(19) United States
(12) Patent Application Publication
(10) Pub. No.: US 2013/0234680 A1
(43) Pub. Date: Sep. 12, 2013

(54) POWER SYSTEM STABILIZATION

(71) Applicant: GENERAL ELECTRIC COMPANY, Schenectady, NY (US)

(72) Inventors: Amol Rajaram Kolwalkar, Bangalore (IN); Rajni Kant Burra, Bangalore (IN); Gurunath Gurrala, Bangalore (IN)

(73) Assignee: GENERAL ELECTRIC COMPANY, Schenectady, NY (US)

(21) Appl. No.: 13/791,704

(22) Filed: Mar. 8, 2013

(30) Foreign Application Priority Data
Mar. 8, 2012 (IN) 879/CHE/2012

(51) Int. Cl. H02P 9/10

(52) U.S. Cl. CPC H02P 9/105
USPC 322/58

(57) ABSTRACT

A method for damping power oscillation in a power system includes generating synchronized generator speed signals by time stamping a plurality of generator speed signals. The synchronized speed signals are transmitted to a control station for determining power oscillations in the power system. The control station provides damping control signals to a plurality of damping devices based on power oscillations in the power system.

### CROSS-REFERENCE TO RELATED APPLICATION

This application claims priority to and benefit of India Patent Application No. 879/CHE/2012, entitled “Power System Stabilization”, filed Mar. 8, 2012, which is herein incorporated by reference in its entirety.

### BACKGROUND

Embodiments of the present invention relate generally to a power flow in a power system. More specifically, the embodiments relate to damping of power system oscillations.

The power system is a complex network comprising of numerous generators, transmission lines, a variety of loads and transformers. With increasing power demand in the power system, some transmission lines are more stressed than was planned when they were built. Since stressed conditions can lead a system to unstable conditions, power system stability has become an important issue. In simple terms, power system stability is defined as the ability of the power system to return to a normal state after a disturbance. The disturbance may be a fault, a loss of a generator or even a sudden increase in power loading which results in power oscillations in power system.

To stabilize the power system, damping measures to damp the power oscillations are utilized. Most of the existing approaches for damping measures are initiated merely from the point of view of single subsystems, which are independent in their operation. The damping measures are not coordinated with other regions. For example, Power system stabilizers (PSSs) are the most common damping control devices in power systems. The PSSs of today usually rely on local information (such as generator rotor speed or electric power) and are effective in damping local modes. Carefully tuned PSSs may also be able to damp some inter-area oscillations; those which can be observed in the monitored local input signals. However, the observability of inter-area modes in local signals is low compared to global signals, and therefore limits to a certain extent the effectiveness of PSSs in damping multiple inter-area oscillations.

For these and other reasons, there is a need for the present invention.

### BRIEF DESCRIPTION

In accordance with an embodiment of the present invention, a method for damping power oscillations in a power system is provided. The method includes generating synchronized generator speed signals by time stamping a plurality of generator speed signals and transmitting the synchronized speed signals to a control station for determining power oscillations in the power system. The method further includes providing damping control signals to a plurality of damping devices based on power oscillations in the power system.

In accordance with another embodiment of the present invention, a system for damping power system oscillations is provided. The system includes speed synchronization modules for generating synchronized generator speed signals, wherein the synchronized generator speed signals are generated by time stamping a plurality of generator speed signals. The system also includes a controller for generating damping control signals based on power system oscillations determined from synchronized speed signals and a plurality of damping devices to generate damping signals in a power system based on damping control signals.

In accordance with yet another embodiment of the present invention, a method for synchronizing generator speed signals is provided. The method includes time stamping a plurality of generator speed signals and transmitting the time stamped generator speed signals to a control station.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of a power system network illustrating a system for damping power system oscillations in accordance with an embodiment of the present invention;

FIG. 2 is a block diagram of a power control system 50 for damping power system oscillations in accordance with an embodiment of the present invention;

FIG. 3 is a block diagram illustrating details of a speed synchronization module in accordance with an embodiment of the present invention;

FIG. 4 is a block diagram illustrating details of another speed synchronization module in accordance with an embodiment of the present invention; and

FIG. 5 is a flowchart representing a method of damping power oscillations in a power system in accordance with an embodiment of the present invention.

### DETAILED DESCRIPTION

As used herein, the term “module” refers to software, hardware, or firmware, or any combination of these, or any system, process, or functionality that performs or facilitates the processes described herein.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

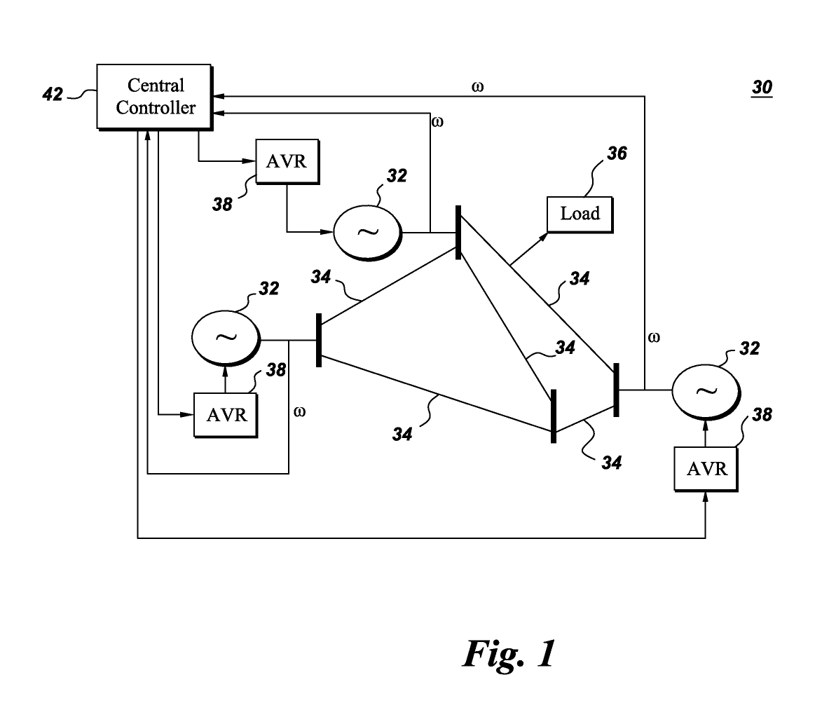

FIG. 1 shows a power system network 30 illustrating a system for damping power system oscillations in accordance with an embodiment of the present invention. Power system network 30 includes generators 32, transmission lines 34, and load 36. Power system network 30 further includes damping devices such as automatic voltage regulator (AVR) 38 to dampen power system oscillations. Other damping devices include a Flexible alternating current transmission system FACTS device (not shown) or even a solar plant or wind plant inverter. AVR 38 can dampen power system oscillations by controlling the excitation of generator 32 and thus, controlling power output of the generator based on an input from a central controller 42. Similarly, a FACTS device and a solar or wind plant inverter, for example, can damp power system oscillations by either injecting or absorbing appropriate active and reactive power from the power system network 30 based on an input from central controller 42.

Central controller 42 receives input signals such as generator speed signals (ω) or generator power output signals. Central controller 42 extracts signal components of different frequencies from the input signal and provides appropriate control signals to AVR 38 to cancel out the extracted frequency components. In one embodiment, AVRs 38 may comprise individual controllers (not shown) designed for a secondary purpose such as for reactive power compensation or voltage compensation and output from central controller 42 is added to reference signals of the individual controllers. Thus, each individual controller of AVR 38 in addition to its secondary purpose also acts on command from central controller 42 to damp the power system oscillations. In another embodiment, there may not be any central controller rather there will be individual controllers for each of the damping devices. The individual controllers then directly receive input signals such as generator speed signals (ω) or generator power output signals and based on these input signals they provide damping control signals to respective damping devices.

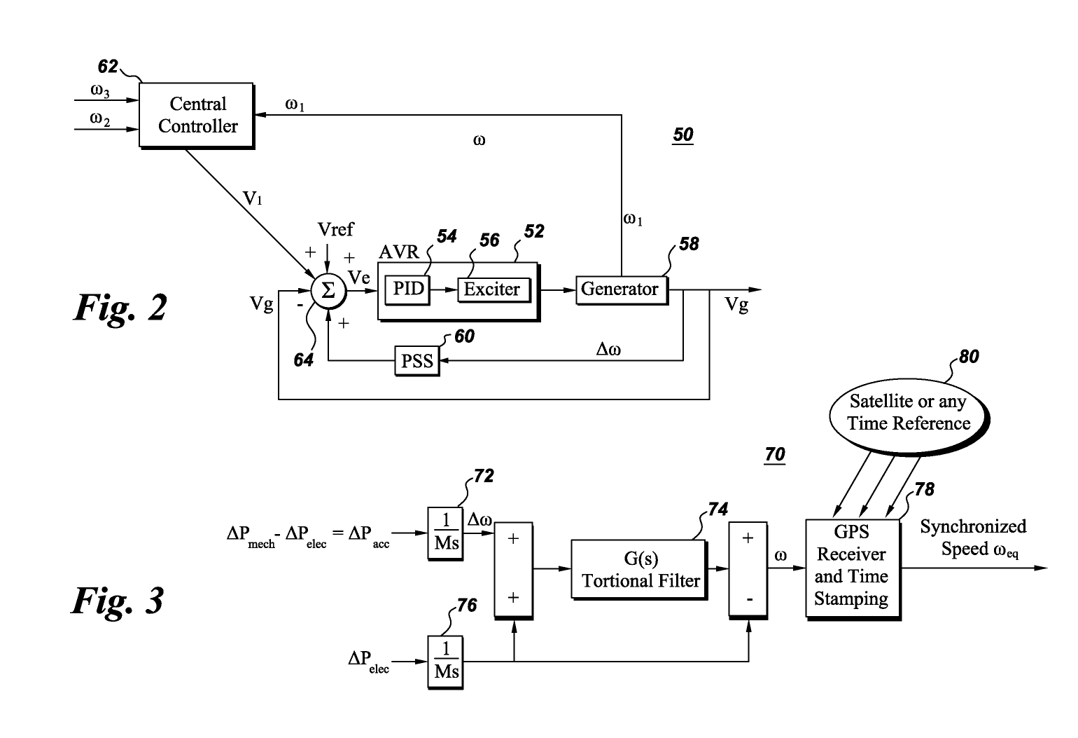

FIG. 2 shows a power control system 50 for damping power system oscillations in accordance with an embodiment of the present invention. Power control system 50 includes an AVR 52, a generator 58, a power system stabilizer (PSS) 60 and a controller 62. Power control system 50 is used for controlling a generator output voltage Vg and also to increase the damping factor of generator which relates to damping of power oscillations.

Generator output voltage Vg is fed back to a summing point 64 and is subtracted from a summation of a reference voltage Vref, a first control signal V1 and a second control signal V2. The reference voltage Vref is generally set by an operator and generally refers to a desired output voltage of the generator. A difference signal Ve is then provided to AVR 52. AVR 52 includes a proportional, integral and derivative (PID) controller 54 and an exciter 56. PID controller 54 and exciter 56 together help in generating a voltage at the generator output terminals which is equal to the combination of reference voltage Vref, first control signal V1 and second control signal V2. PSS 60 provides second control signal V2 for compensating local mode oscillations based on a generator speed deviation signal Δω. PSS 60 can also generate second control signal V2 based on other input signals such as change in generator power output ΔP or speed ω1 or power signal P, for example. PSS 60 utilizes a gain and a phase compensator (not shown) to generate second control signal V2.

Controller 62 may be a central controller located at a remote location or a local controller located near the generator. Controller 62 receives speed input signals ω1, ω2, and ω3 from multiple generators in a single area or multiple generators in various areas. Controller 62 may include a memory for storing data, a processing circuitry for processing data and communication elements such as transmitters and receivers for transmitting and receiving data. Controller 62 further analyzes the speed input signals and identifies inter-area oscillation modes from those signals. Identification of inter-area oscillation modes helps in determining how close the network is to instability. Controller 62 further generates first control signal V1 for damping the inter-area oscillations. In other words controller 62 is similar to PSS 60 but damps a different set of oscillations. In one embodiment, all speed signals are time synchronized i.e., the signals ω1, ω2, and ω3 which are time varying signals also have a time stamp associated with it them to indicate the time at which the speed measurement was taken. By doing so, the time delay associated with transmission of the speed signal from a generator to the central controller will not affect the analysis of the signals. In one embodiment, a geographic positioning system (GPS) may be utilized to time stamp the speed signal. As described earlier, in an embodiment, controller 62 may also provide a control signal to other damping device such as a FACTS device, a solar plant inverter or a wind plant inverter.

In one embodiment, controller 62 may assign different weightages (or weight values) to different synchronized speed signals (ω1, ω2, and ω3) and then process the weighted synchronized speed signals to generate the first control signal. In one embodiment, the weightages for synchronized speed signals may depend on the participation factor of generators. In another embodiment, the weightages may depend on damping or inertia of the generators.

FIG. 3 shows a block diagram illustrating details of a speed synchronization module 70 in accordance with an embodiment of the present invention. In this embodiment, a generator speed ω is calculated based on an accelerating power P_{acc} and an electrical power P_{elec}. A speed deviation signal Δω is generally given by

$$Δ ω = \frac{1}{Ms} ( Δ {P}_{acc} ) \qquad ( 1 )$$

where ‘s’ is a Laplace transform operator and ‘M’ represents an inertia constant. Further, an accelerating power deviation signal ΔP_{acc} is obtained by subtracting an electrical power deviation signal ΔP_{elec} from a mechanical power deviation signal ΔP_{mech} i.e. (ΔP_{mech}−ΔP_{elec}). The above equation is represented by block 72 in speed synchronization module 70.

An overall transfer function for deriving the generator speed signal ω from the electrical power signal P_{elec} is given by:

$$ω = G ( s ) [ \frac{Δ {P}_{elec}}{Ms} + Δ ω ] - \frac{Δ {P}_{elec}}{Ms} \qquad ( 2 )$$

where G(s) is a transfer function of a filter such as a torsional filter or a low pass filter. Speed synchronization module 70 shows G(s) in a block 74 and (ΔP_{elec}/Ms) term in block 76. The resultant generator speed signal ω is then fed to a geographic positioning system (GPS) receiver and time sampling block 78 which associates the generator speed signal ω with a time at which the signal ω was captured or measured and outputs a synchronized generator speed signal ω_{eq}. The GPS receiver and time sampling block 78 receives time signals from either a satellite 80 which also provides time reference to other generators and central controller 62 (FIG. 2) or any other time reference common for all other generators. When central controller 62 receives synchronized generator speed signals from multiple locations, it can then determine the inter-area oscillations between two areas or local oscillations between two generators based on the difference between related synchronized generator speed signals. The oscillation information is then further utilized to generate an appropriate control signal for the power system stabilizer (e.g., PSS 60).

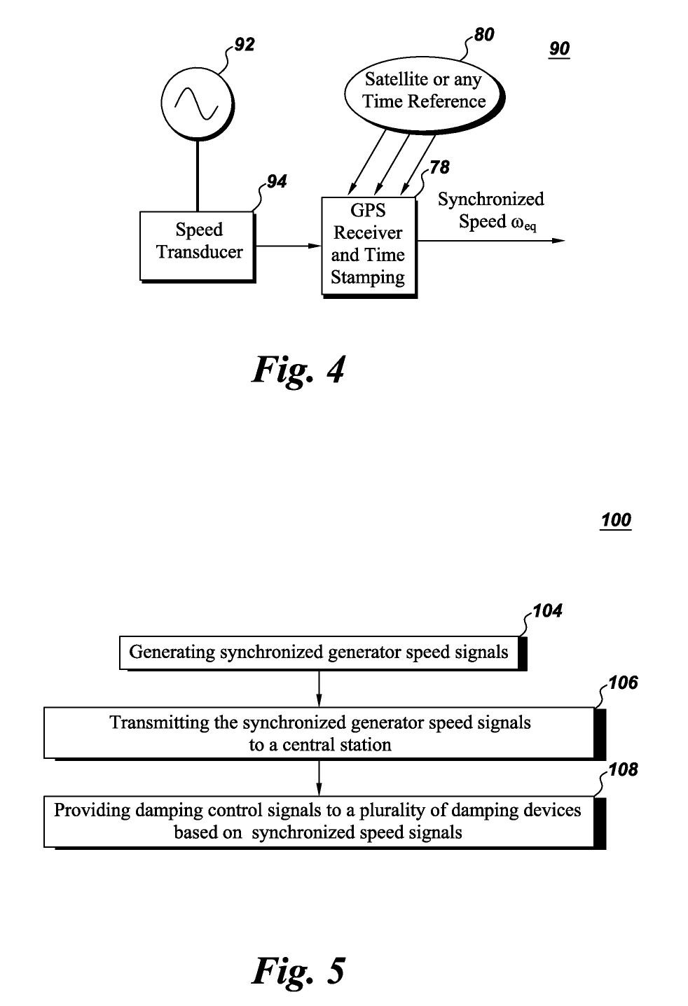

FIG. 4 shows a block diagram illustrating details of another speed synchronization module 90 in accordance with an embodiment of the present invention. In this embodiment, the generator speed signal ω is directly measured by utilizing a speed transducer 94 connected to a generator 92. The generator speed signal ω is then transmitted to GPS receiver and time stamping block 78 for generating the synchronized generator speed signal ω_{eq}. As in earlier embodiment, the GPS receiver and time sampling block 78 receives time signals from satellite 80 which also provides time reference to other generators and central controller. In one embodiment, a time reference from a server (not shown) may also be used time stamp the speed signal. In one embodiment, if a phasor measurement unit (PMU) is installed at the generating bus then it may be modified by including an additional channel to output synchronized generator speed signal. Basically, speed transducer 92 may provide the speed signal as an additional input to PMU and then PMU can output the synchronized generator speed signal on a dedicated output channel with a time stamp.

FIG. 5 shows a flowchart 100 representing a method of damping power oscillations in a power system in accordance with an embodiment of the present invention. The method includes generating synchronized generator speed signals by time stamping a plurality of generator speed signals in step 104. The plurality of generator speed signals may be directly measured or can be calculated based on accelerating power as shown in FIG. 3. The time reference for time stamping the generator speed signals may be either obtained from GPS or any other time reference such as from a server. At step 106, the synchronized speed signals are transmitted to a central control station which determines power oscillations such as inter-area oscillations or local mode oscillations in the power system from synchronized speed signals. Finally, at step 108, central controller generates and provides damping control signals to a plurality of damping devices based on power oscillations.

As discussed in detail above, embodiments of the present invention function to provide methods and systems to synchronize generator speed signals and damp power system oscillations. Although the present discussion specifically focuses on damping power system oscillations, embodiments of the present invention are also applicable to other applications where synchronized generator speed signals may be utilized. For example, the applications may include wide area frequency control or load control.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for damping power oscillations in a power system comprising:
generating synchronized generator speed signals by time stamping a plurality of generator speed signals;
transmitting the synchronized speed signals to a control station for determining power oscillations in the power system; and
providing damping control signals to a plurality of damping devices based on power oscillations in the power system.

2. The method of claim 1, wherein each of the plurality of generator speed signals is calculated based on a respective generator accelerating power signal and a generator electrical power signal.

3. The method of claim 2, wherein calculation of the generator speed signal comprises obtaining a speed deviation signal by integrating the accelerating power signal.

4. The method of claim 1, wherein each of the plurality of generator speed signals is measured from a respective generator speed transducer.

5. The method of claim 1, wherein time stamping the plurality of generator speed signals comprises utilizing a geographic position system (GPS) time reference or a server time reference.

6. The method of claim 1, wherein determining power oscillations in the power system comprises determining inter-area oscillations or local oscillations.

7. The method of claim 1, wherein the plurality of damping devices comprise at least one of an automatic voltage regulator, a flexible alternating current transmission device, a solar plant inverter or a wind plant inverter.

8. The method of claim 1, wherein generating synchronized generator speed signals further comprises providing each of the synchronized speed signals on a dedicated channel of a phasor measurement unit (PMU).

9. The method of claim 1, wherein the control station includes a central control station for the plurality of damping devices or a local control station for each of the plurality of damping devices.

10. The method of claim 1, wherein providing damping control signals comprises assigning weight values to synchronized speed signals.

11. The method of claim 10, wherein the weight values depend on generator inertial values or generator participation factors.

12. A system for damping power system oscillations comprising:
speed synchronization modules for generating synchronized generator speed signals, wherein the synchronized generator speed signals are generated by time stamping a plurality of generator speed signals;
a controller for generating damping control signals based on power system oscillations determined from synchronized speed signals; and
a plurality of damping devices to generate damping signals in a power system based on damping control signals.

13. The system of claim 12, wherein the speed synchronization module determines each of the plurality of generator speed signals based on a respective generator accelerating power signal and a generator electrical power signal.

14. The system of claim 13, wherein determination of the generator speed signal comprises obtaining a speed deviation signal by integrating the accelerating power signal.

15. The system of claim 12, wherein the speed synchronization module includes a generator speed transducer to generate each of the plurality of generator speed signals.

16. The system of claim 12, wherein time stamping the plurality of generator speed signals comprises utilizing a geographic position system (GPS) time reference or phasor measurement unit (PMU) time reference.

17. The system of claim 12, wherein the damping device comprises an automatic voltage regulator or a flexible alternating current transmission device.

18. The system of claim 12, wherein each of the plurality of damping devices adds the damping control signal to secondary control signals.

19. The system of claim 12, wherein secondary control signals comprise a generator output voltage control signal and a local power system stabilizer control signal.

20. A method for synchronizing generator speed signals comprising:
time stamping a plurality of generator speed signals; and
transmitting the time stamped generator speed signals to a control station.
